(19) United States
(12) Patent Application Publication
(10) Pub. No.: US 2026/0216592 A1
(43) Pub. Date: Jul. 30, 2026

(54) METHOD AND APPARATUS FOR CONTROLLING SHOOTING IN GAME, STORAGE MEDIUM, AND ELECTRONIC DEVICE

(71) Applicant: NETEASE (HANGZHOU) NETWORK CO., LTD., Hangzhou (CN)

(72) Inventors: Xin XU, Hangzhou (CN); Yinchen LIU, Hangzhou (CN)

(21) Appl. No.: 19/144,119

(22) PCT Filed: May 29, 2023
(86) PCT No.: PCT/CN2023/096938

§ 371 Date: Jun. 27, 2025

(30) Foreign Application Priority Data
Dec. 27, 2022 (CN) 202211690744.1

(51) Int. Cl. A63F 13/218; A63F 13/533; A63F 13/55; A63F 13/837

(52) U.S. Cl. CPC A63F 13/218; A63F 13/533; A63F 13/55; A63F 13/837

(57) ABSTRACT

The present disclosure provides a method for controlling shooting in a game, including: determining that a shooting mode of a target virtual item in the game is a single-fire mode; in response to the first pressing operation, controlling the target virtual item to fire a sub-virtual item; in response to a duration of the first pressing operation meeting a first preset duration, controlling, in the single-fire mode, the target virtual item to fire the sub-virtual item at a first preset time interval; and in response to the duration of the first pressing operation meeting a second preset duration, controlling the target virtual item to fire the sub-virtual item at a second preset time interval.

### CROSS-REFERENCE TO RELATED APPLICATION

The present disclosure is a 371 national phase application of PCT Application No. PCT/CN2023/096938 filed May 29, 2023, which claims priority to Chinese Patent Application No. 202211690744.1 filed with the China National Intellectual Property Administration on Dec. 27, 2022 and entitled “METHOD AND APPARATUS FOR CONTROLLING SHOOTING IN GAME, STORAGE MEDIUM, AND ELECTRONIC DEVICE”, the entire contents of both of which applications are incorporated herein by reference.

### TECHNICAL FIELD

The present disclosure relates to the field of computer technologies, and specifically relates to a method, system, and apparatus for controlling shooting in a game.

### BACKGROUND

In shooter games, most virtual guns have a plurality of shooting modes, such as a single-fire mode and a burst-fire mode. In the single-fire mode, the virtual gun may fire one virtual bullet when a game user clicks or long-presses a corresponding attack control once. In the burst-fire mode, the virtual gun may fire virtual bullets continuously when the user long-presses a corresponding attack control. Furthermore, when the virtual gun is in the single-fire mode, if the user intends to carry out a burst fire operation, the user needs to click a corresponding switching control to switch the shooting mode of the virtual gun.

However, the switching operation carried out on the shooting mode may cause the shooting process to be terminated, and the shooting operation can be continued only after the switching of the shooting mode is completed, which increases the complexity of the shooting operation of the user and is not conducive to improving the continuity of the shooting operation of the user.

### SUMMARY

The present disclosure provides a method, system, and apparatus for controlling shooting in a game to reduce the complexity of a shooting operation of a user, improve the continuity of the shooting operation of the user, and enhance gaming experience of the user.

According to a first aspect, the present disclosure provide a method for controlling shooting in a game, including: determining that a shooting mode of a target virtual item in the game is a single-fire mode, where a game interface is provided through a terminal device, and the game interface comprises an attack control element; receiving a first control operation for the attack control element, the first control operation including a first pressing operation and a first lifting operation; in response to the first pressing operation, controlling the target virtual item to fire a sub-virtual item; in response to a duration of the first pressing operation meeting a first preset duration, controlling, in the single-fire mode of the target virtual item, the target virtual item to fire the sub-virtual item at a first preset time interval; and in response to the duration of the first pressing operation meeting a second preset duration, controlling the target virtual item to fire the sub-virtual item at a second preset time interval, where the second preset duration is longer than the first preset duration, and the second preset time interval corresponds to a time interval for the target virtual item to fire the sub-virtual item in a burst-fire mode.

According to a second aspect, the present disclosure provide one or more non-transitory computer-readable storage media containing, in any combination, computer program code that, when executed by a computer system, perform the steps of the method for controlling shooting in a game according to any embodiment as described above.

According to a third aspect, the present disclosure provides a system including one or more memory collectively containing one or more programs, and one or more processors, where the one or more processors are configured to, individually or collectively, perform the steps of the method for controlling shooting in a game according to any embodiment as described above.

### BRIEF DESCRIPTION OF THE DRAWINGS

To more clearly describe technical solutions of the embodiments of the present disclosure, drawings to be used in the description of the embodiments may be briefly introduced below. Apparently, the drawings described below are merely some embodiments of the present disclosure. For those skilled in the art, other drawings may also be obtained based on these drawings without creative efforts.

FIG. 1 is a schematic scene diagram of a system for controlling shooting in a game according to an embodiment of the present disclosure;

FIG. 2 is a schematic flowchart of a method for controlling shooting in a game according to an embodiment of the present disclosure;

FIG. 3 is a schematic operation diagram of carrying out a first control operation on an attack control element in a game interface according to an embodiment of the present disclosure;

FIG. 4 is another schematic flowchart of a method for controlling shooting in a game according to embodiment of the present disclosure;

FIG. 5 is another schematic operation diagram of carrying out a first control operation on an attack control element in a game interface according to an embodiment of the present disclosure;

FIG. 6 is a schematic structural diagram of an apparatus for controlling shooting in a game according to an embodiment of the present disclosure; and

FIG. 7 is a schematic structural diagram of an electronic device according to an embodiment of the present disclosure.

### DETAILED DESCRIPTION

The technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those skilled in the art based on the embodiments in the present disclosure without any creative effort shall fall within the scope of protection of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, to perform a particular function.

The present disclosure provides a method, system, and apparatus for controlling shooting in a game. A game interface is provided by a terminal device, where the game interface includes an attack control element, and it is determined that the shooting mode of the target virtual item in the game is the single-fire mode. Then, a first control operation for the attack control element is received, the first control operation including the first pressing operation and the first lifting operation. In response to the first pressing operation, the target virtual item is controlled to fire the sub-virtual item. Then, in response to the duration of the first pressing operation meeting the first preset duration, the target virtual item is controlled, in the single-fire mode of the target virtual item, to fire the sub-virtual item at the first preset time interval. In response to the duration of the first pressing operation meeting the second preset duration, the target virtual item is controlled to fire the sub-virtual item at the second preset time interval, where the second preset duration is longer than the first preset duration, and the second preset time interval corresponds to the time interval for the target virtual item to fire the sub-virtual item in the burst-fire mode. Therefore, in the single-fire mode, the target virtual item can be used to carry out burst fire without switching the shooting mode of the target virtual item. The disclosed embodiments reduce the complexity of the shooting operation of the user, improve the continuity carrying out the shooting operation by the game user, and provide the user a feeling of transitioning the target virtual item from the single-fire state to the burst-fire state, thereby improving the user's gaming experience.

The embodiments of the present disclosure provide a method, system, and apparatus for controlling shooting in a game.

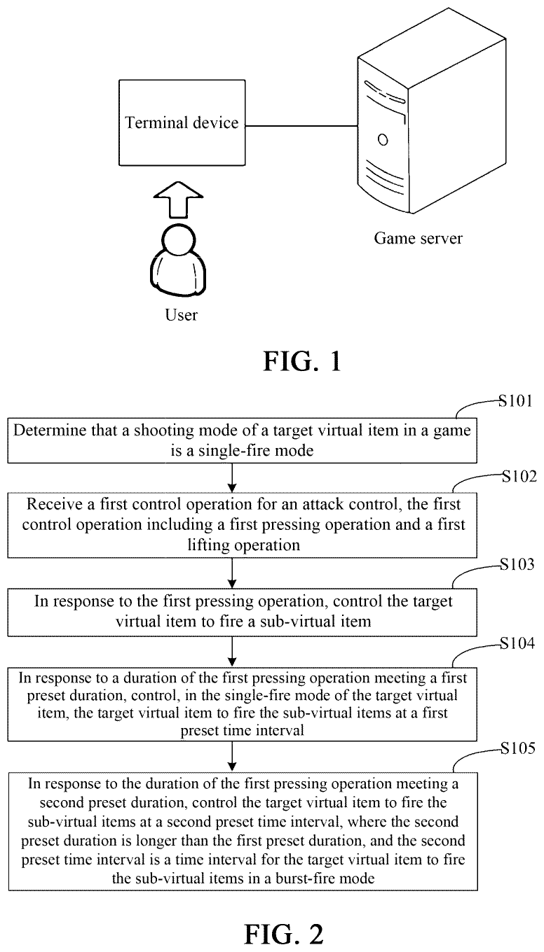

Referring to FIG. 1, FIG. 1 is a schematic scene diagram of a system for controlling shooting in a game according to an embodiment of the present disclosure. The system for controlling shooting in a game may include any one of apparatuses for controlling shooting in a game provided by the embodiments of the present disclosure. The apparatus for controlling shooting in a game may be specifically integrated in an electronic device such as a terminal or a server, where the terminal may be a device such as a smart phone, a tablet computer, a smart Bluetooth device, a notebook computer, or a Personal Computer (PC), and the server may be a single server or a server cluster composed of a plurality of servers.

The electronic device may provide a game interface through a terminal device, and the game interface includes an attack control; determines that a shooting mode of a target virtual item in the game is a single-fire mode; receives a first control operation for the attack control, the first control operation including a first pressing operation and a first lifting operation; in response to the first pressing operation, controls the target virtual item to fire a sub-virtual item; in response to a duration of the first pressing operation meeting a first preset duration, controls, in the single-fire mode of the target virtual item, the target virtual item to fire the sub-virtual items at a first preset time interval; and in response to the duration of the first pressing operation meeting a second preset duration, controls the target virtual item to fire the sub-virtual items at a second preset time interval, where the second preset duration is longer than the first preset duration, and the second preset time interval is a time interval for the target virtual item to fire the sub-virtual items in a burst-fire mode.

Specifically, as shown in FIG. 1, the system for controlling shooting in a game may include a game server and a terminal device connected to the game server, where a client of a shooter game application may run in the terminal device. In an example, the shooter game application may be a First-Person Shooter (FPS) game application. In a shooter game, a user can use fingers or an input device (such as a keyboard and mouse, a keyboard, or a gamepad) to perform a control operation such as clicking, long-pressing, and heavy-pressing on an attack control in a game interface, so as to trigger the above-mentioned game server to control a target virtual character to use a virtual item to carry out a virtual attack on another virtual character, where the target virtual character may be understood as a virtual object controlled by the user who logs into a client of the shooter game application. The game interface may also be configured to display a game picture, and when the shooter game application is an FPS game application, the game picture may be a game scene picture within a first-person field of view of the target virtual character. The target virtual item may be a virtual shooting item used by the target virtual character in the game to carry out a shooting action. The target virtual item may be one of a variety of virtual shooting items such as a crossbow, a catapult, a laser gun, a tank, and a cannon. The shooting mode of the target virtual item may be a single-fire mode or a burst-fire mode. The single-fire mode is that the target virtual item may carry out shooting once when the user clicks the attack control once, and the shooting may be a single-fire, and more specifically, only one sub-virtual item (for example, a bomb or a bullet) is fired, or it may be a burst-fire, and more specifically, a preset number of sub-virtual items are fired continuously (for example, three sub-virtual items are fired continuously). The burst-fire mode is that when the user long-presses the attack control, the target virtual item may fire the sub-virtual items at the second preset time interval to achieve burst fire of the sub-virtual items.

In a specific example, during the game, when intending to use the target virtual item in the single-fire mode to continuously shoot the sub-virtual items, the user can carry out a first control operation (for example, a long-press operation), including a first pressing operation and a first lifting operation, on the attack control in the game interface to trigger the game server to receive the first control operation. In response to receiving the first pressing operation, the target virtual item is controlled to carry out a single-fire or a burst-fire. Then, in response to a duration of the first pressing operation meeting the first preset duration (for example, 1S), the game server may control, in the single-fire mode of the target virtual item, the target virtual item to fire the sub-virtual item at the first preset time interval. After that, in response to the duration of the first pressing operation meeting the second preset duration (for example, 5S), the game server may control the target virtual item to fire the sub-virtual items at the second preset time interval, so that the target virtual item in the single-fire mode can carry out both single-fire and burst-fire, which helps assist the game user in some emergency specific scenes (for example, in a scene where the target virtual item the user uses is in the single-fire mode but the user urgently needs to carry out a burst fire operation) to more conveniently complete the desired operation, thereby causing the shooting experience of the user more comfortable.

As shown in FIG. 2, FIG. 2 is a schematic flowchart of a method for controlling shooting in a game according to an embodiment of the present disclosure. The method provides a game interface through a terminal device, and the game interface includes an attack control. The method specifically includes the following steps.

S101: Determine that a shooting mode of a target virtual item in the game is a single-fire mode.

In this embodiment, the game may be a shooter game (for example, a first-person shooter game, a third-person shooter game, or the like). The terminal device may have a client of a shooter game application running thereon. The target virtual item may be a virtual shooting item used when the target virtual character in the game carries out a shooting action, where the target virtual character may be a virtual object controlled by a user who logs into the client of the shooter game application running in the terminal device, and the user can control the target virtual character through the terminal device.

Specifically, the game interface may also be configured to display a game picture, and when the shooter game application is a first-person shooter game application, the game picture may be a game scene picture within a first-person field of view of the target virtual character. The target virtual item may be an attack virtual shooting item such as a virtual gun and a virtual cannonball, for example, a pistol, a submachine gun, a light machine gun, a sniper rifle, a mortar, and the like. The user may control, through the terminal device, the target virtual character in the game to use the target virtual item to carry out shooting operations to complete a shooter game task. The shooter game task may include a confrontation shooter game task in which a mission is won by killing all enemy virtual characters, a confrontation shooter game task in which a mission is won by the number of virtual objects generated in a target zone being killed reaching a target threshold, and the like.

The shooting mode of the target virtual item may be any one of a single-fire mode, a burst-fire mode, and other shooting modes. The single-fire mode is that the target virtual item may carry out a single-fire (such as only fire one sub-virtual item) or a burst-fire (such as continuously fire a preset number of sub-virtual items) when the user clicks the attack control in the game interface once. The burst-fire mode is that when the user long-presses the attack control, the target virtual item may fire the sub-virtual items at the second preset time interval to achieve burst fire of the sub-virtual items. The sub-virtual item may be a virtual bullet.

Furthermore, during specific implementation, the shooting mode of the target virtual item may be a default shooting mode (for example, the single-fire mode) of the target virtual item in the game, or may be preset by the user of the terminal device according to own needs of the user.

S102: Receive a first control operation for an attack control, the first control operation including a first pressing operation and a first lifting operation.

Specifically, in a shooter game, the user can use fingers or an input device (such as a keyboard and mouse, a keyboard, or a gamepad) to carry out a control operation such as clicking, long-pressing, and heavy-pressing on the attack control in the game interface, so as to trigger the apparatus for controlling shooting in a game to control, in response to the control operation, the target virtual character to carry out shooting by using the target virtual item.

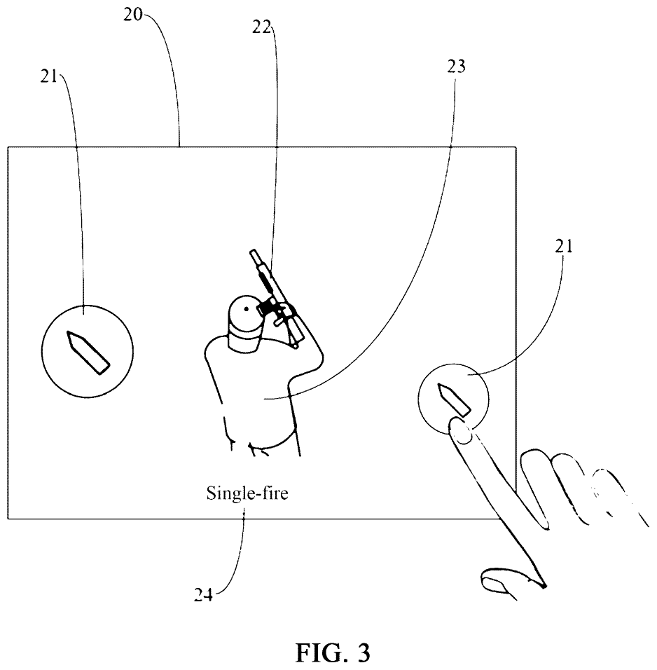

In a specific embodiment, as shown in FIG. 3, the attack control 21 in the game interface 20 may be a virtual button, and there may be one or a plurality of virtual buttons. For example, as shown in FIG. 3, the game interface 20 may include two attack controls 21, such as a first attack control and a second attack control, and the first attack control and the second attack control may be respectively arranged on opposite sides of the game interface 20. In some embodiments, as shown in FIG. 3, the target virtual character 23 and the target virtual item 22 may be displayed in the game interface 20, and when the user clicks, long-presses, or heavy-presses the first attack control or the second attack control, the target virtual character 23 may carry out shooting by using the target virtual item 22, where the target virtual item 22 may be a virtual shooting item possessed and being used by the target virtual character 23 in the game.

In this embodiment, the first control operation may be a long-press operation. In one example, for a mobile game, as shown in FIG. 3, the user of the terminal device may complete the first control operation by long-pressing the attack control 21 in the game interface 20 with a finger. In another example, for a PC game, the user of the terminal device can carry out the first control operation on the attack control 21 in the game interface 20 by using an input device such as a keyboard and mouse, a keyboard, or a gamepad. For example, the first control operation may be carried out on the attack control 21 in the game interface 20 by long-pressing a left button of a mouse.

S103: In response to the first pressing operation, control the target virtual item to fire a sub-virtual item.

In this embodiment, the first pressing operation occurs before the first lifting operation, and more specifically, the apparatus for controlling shooting in the game may first receive the first pressing operation and then receive the first lifting operation.

Specifically, when receiving the first pressing operation, the apparatus for controlling shooting in a game may, in response to receiving the first pressing operation, control the target virtual item to carry out single-fire shooting or burst-fire shooting once. More specifically, at the moment of receiving the first pressing operation (such as the user starts to press the attack control), the apparatus for controlling shooting in a game may immediately control the target virtual item to carry out single-fire shooting or burst-fire shooting once to meet the basic requirement of carrying out single shooting when the target virtual item is in the single-fire mode.

In one embodiment, the target virtual item is configured with game parameters that affect the shooting accuracy of the target virtual item, such as a recoil parameter. Such game parameters reduce the accuracy of the target virtual item when the target virtual item carries out shooting at a high-frequency shooting speed. For example, a display area of a crosshair mark displayed on a graphical user interface becomes larger. Through the single-fire mode, the player can carry out single-fire shooting or burst-fire shooting once when the player presses the attack control for a long time, thereby ensuring the accuracy of the shooting.

S104: In response to a duration of the first pressing operation meeting a first preset duration, control, in the single-fire mode of the target virtual item, the target virtual item to fire the sub-virtual items at a first preset time interval.

S105: In response to the duration of the first pressing operation meeting a second preset duration, control the target virtual item to fire the sub-virtual items at a second preset time interval, where the second preset duration is longer than the first preset duration, and the second preset time interval is a time interval for the target virtual item to fire the sub-virtual items in the burst-fire mode.

In this embodiment, the first preset time interval is greater than the second preset time interval. Furthermore, in this embodiment, when the duration of the first pressing operation is longer than the first preset duration (such as the user continuously presses the attack control for more than the first preset duration), the target virtual item is controlled, in the single-fire mode of the target virtual item, to fire the sub-virtual items at a larger time interval (such as the first preset time interval), and when the duration of the first pressing operation is longer than the second preset duration (such as the user continuously presses the attack control for more than the second preset duration), the target virtual item is controlled to fire the sub-virtual items at a smaller time interval (such as the second preset time interval), so that not only the target virtual item, when in the single-fire mode, is allowed to meet the further demand of carrying out burst fire, so as to reduce the complexity of the shooting operation of the user and improve the continuity of the shooting operation of the user, but also the user can be provided with a feeling of the target virtual item transitioning from the single-fire state to the burst-fire state, which greatly improves the gaming experience of the user.

It is understandable that, after the target virtual item is controlled to carry out shooting once in response to receiving the first pressing operation, the target virtual item may not fire the sub-virtual item until the duration of the first pressing operation meets the first preset duration. Furthermore, only when the duration of the first pressing operation is the first preset duration, can the apparatus for controlling shooting in a game control the target virtual item to carry out shooting once again. Then, before the duration of the first pressing operation meets the second preset duration, each time the duration of the first pressing operation increases by the first preset time interval, the apparatus for controlling shooting in a game may control the target virtual item to carry out shooting once again, so as to achieve burst fire of the target virtual item in the single-fire mode by firing the sub-virtual items at the first preset time interval.

Then, after the duration of the first pressing operation meets the second preset duration, each time the duration of the first pressing operation increases by the second preset time interval, the apparatus for controlling shooting in a game may control the target virtual item to carry out shooting once again, so as to achieve burst fire of the target virtual item by firing the sub-virtual items at the second preset time interval.

Specifically, the first preset duration, the second preset duration, and the first preset time interval may be determined by investigating shooting operation habits of several game users in the game. In an example, the first preset duration and the second preset duration may be 1 second and 5 seconds respectively. In an example, the first preset time interval may be 1 second.

Furthermore, it is understandable that, in this embodiment, at an initial stage when the user presses the attack control, and more specifically, when the duration of the user pressing the attack control is longer than the first preset duration and shorter than the second preset duration, the target virtual item is controlled to carry out burst fire at a larger time interval (such as the first preset time interval), and only when the duration of the user pressing the attack control is longer than the second preset duration, the time interval between two adjacent shootings when the target virtual item carrying out burst fire is further reduced to be consistent with the time interval between two adjacent shootings when the target virtual item carrying out burst fire in the burst-fire mode (such as the second preset time interval), which is equivalent to introducing a judgment mechanism to judge whether the user currently is in urgent need to use the target virtual item to carry out burst fire, thereby providing a reaction process for the user, so as to avoid the unexpected burst fire caused by an operational error to a certain extent.

In some specific embodiments, before controlling the target virtual item to fire the sub-virtual items at the second preset time interval, the method for controlling shooting in the game may also include: in response to the duration of the first pressing operation meeting the second preset duration, controlling the target virtual item to fire the sub-virtual items at a time interval gradually decreasing from the first preset time interval to the second preset time interval.

Specifically, after the duration of the first pressing operation meets the second preset duration (such as the duration of the user continuously pressing the attack control reaches the second preset duration), as the duration of the first pressing operation gradually increases, the apparatus for controlling shooting in a game may control the target virtual item to fire the sub-virtual items at the time interval that gradually decreases from the first preset time interval to the second preset time interval according to a preset gradient, where the preset gradient may be a preset fixed value.

It should be noted that, during the first pressing operation, when the duration of the first pressing operation is longer than the first preset duration and shorter than the second preset duration, the target virtual item may carry out burst fire by firing the sub-virtual items at the first preset time interval. Moreover, after the duration of the first pressing operation is longer than the second preset duration, as the duration of the first pressing operation increases, the frequency of carrying out burst fire of the target virtual item may gradually increase, and more specifically, the time interval between two adjacent shootings when the target virtual item performs burst fire may gradually decrease.

Furthermore, if the duration of the first pressing operation is long enough, the frequency of the target virtual item carrying out burst fire may eventually reach a preset maximum value during the first touching operation, and after reaching the maximum value, the frequency of the target virtual item carrying out burst fire may remain at the maximum value and may no longer change. More specifically, if the duration of the first pressing operation is long enough, during the first touching operation, the time interval between two adjacent shootings when the target virtual item carries out burst fire may eventually be reduced to the second preset time interval, and after being reduced to the second preset time interval, the time interval between two adjacent shootings when the target virtual item carries out burst fire may remain at the second preset time interval and may no longer change. Specifically, the maximum value may be determined by the characteristics of the target virtual item, and different target virtual items may correspond to different maximum values. In one example, the maximum value may correspondingly be the maximum shooting frequency of the target virtual item, or may be the frequency of the target virtual item carrying out burst fire in the burst-fire mode.

Furthermore, if the duration of the first pressing operation is not sufficient to increase the frequency of the target virtual item carrying out burst fire to the maximum value, during the first touching operation, the frequency of the target virtual item carrying out burst fire may always be less than the maximum value or the frequency of the target virtual item carrying out burst fire in the burst-fire mode. More specifically, if the duration of the first pressing operation is not long enough for the time interval between two adjacent shootings when the target virtual item carries out burst fire to be reduced to the frequency of the second preset time interval, during the first touching operation, the time interval between two adjacent shootings when the target virtual item carries out burst fire may always be larger than the second preset time interval. Therefore, when the target virtual item is in the single-fire mode, not only can the burst fire function of the target virtual item be realized, but also the user can experience the sense of impact by the gradually increasing shooting frequency, which greatly enhances the gaming experience of the user.

In addition, in this embodiment, before controlling the target virtual item to fire the sub-virtual items at the second preset time interval, in response to the duration of the first pressing operation meeting the second preset time interval, the target virtual item is controlled to fire the sub-virtual items at the time interval gradually decreasing from the first preset time interval to the second preset time interval. This is also conducive to obtaining shooting stability during conventional single shooting. At the same time, it also facilitates the operation of the user and realizes automatic switching to automatic shooting, and more specifically, high damage brought by rapid shooting can be obtained.

In some embodiments, the above method for controlling shooting in a game may further include S106: In response to the first lifting operation, control the target virtual item to stop firing the sub-virtual item.

Specifically, when receiving the first lifting operation, the apparatus for controlling shooting in a game may, in response to receiving the first lifting operation, control the target virtual item to stop firing the sub-virtual item.

Afterwards, if the user intends to use the target virtual item to carry out burst fire of the sub-virtual items, the burst fire of the sub-virtual items may be achieved in two ways. One way is performing the first control operation on the attack control in the game interface again to trigger the apparatus for controlling shooting in a game to perform the above-mentioned S102, S103, S104, and S105 again, so as to achieve the target virtual item carrying out burst fire in the single-fire mode. The other way is switching the shooting mode of the target virtual item from the single-fire mode to the burst-fire mode, and then performing a corresponding control operation (such as a click operation or a long-press operation) on the attack control in the game interface to trigger the apparatus for controlling shooting in a game to, in response to the touching operation, control, in the burst-fire mode of the target virtual item, the target virtual character to use the target virtual item to carry out burst fire by firing the sub-virtual items at the second preset time interval, thereby achieving the target virtual item carrying out burst fire in the single-fire mode.

Furthermore, it should be noted that, compared to the related art in which the target virtual item in the single-fire mode is directly controlled to fire the sub-virtual items at a fixed time interval for carrying out burst fire during the user long-pressing the attack control, in this embodiment, the target virtual item in single-fire mode is controlled to fire the sub-virtual items at the larger first preset time interval for carrying out burst fire during the user long-pressing the attack control, and then fire the sub-virtual items at the time interval that gradually decreases from the larger first preset time interval to the smaller second preset time interval for carrying out burst fire, and finally fires the sub-virtual items at the smaller second preset time interval for carrying out burst fire. This not only allows the target virtual item to be used for carrying out burst fire without the need for the user to switch the shooting mode of the target virtual item, but also allows the user to clearly feel that the shooting state of the target virtual item is transitioning from single shooting to burst fire, which can better give the user the sense of impact.

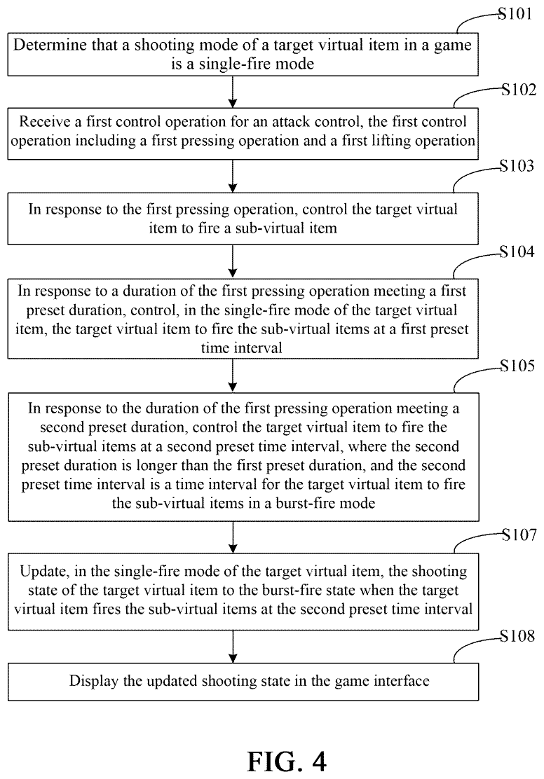

In some embodiments, as shown in FIG. 4, the above method for controlling shooting in a game may further include: S107: Update, in the single-fire mode of the target virtual item, the shooting state of the target virtual item to the burst-fire state when the target virtual item fires the sub-virtual items at the second preset time interval; and S108: Display the updated shooting state in the game interface.

Specifically, during the first pressing operation, after the time interval between two adjacent shootings when the target virtual item carries out burst fire is reduced the second preset time interval, the target virtual item may carry out burst fire of the sub-virtual items at the second preset time interval. Furthermore, in a specific implementation, the above apparatus for controlling shooting in a game can update the shooting state of the target virtual item from an initial shooting state (such as the single-fire state) to the burst-fire state when the time interval between two adjacent shootings when the target virtual item carries out burst fire is reduced to the second preset time interval during the first pressing operation, so that the target virtual item in the single-fire mode can have two shooting states, namely, the single-fire state and the burst-fire state.

In some specific embodiments, the above method for controlling shooting in a game may further include: S109: When the target virtual item fires the sub-virtual items at a time interval greater than the second preset time interval and less than the first preset time interval, update, in the single-fire mode of the target virtual item, the shooting state of the target virtual item from the initial shooting state (such as the single-fire state) to a shooting state transitioning from single-fire to burst-fire.

Correspondingly, the above-mentioned S107 may specifically include: when the target virtual item fires the sub-virtual items at the second preset time interval, update, in the single-fire mode of the target virtual item, the shooting state of the target virtual item from the shooting state transitioning from single-fire to burst-fire to the burst-fire state. Therefore, the target virtual item in the single-fire mode can have three shooting states: the single-fire state, the shooting state transitioning from single-fire to burst-fire, and the burst-fire state.

Moreover, in this embodiment, by displaying the updated shooting state of the target virtual item in the game interface, the user can visually feel the target virtual item transitioning from the single-fire state to the burst-fire state, thereby further improving the gaming experience of the user.

In some embodiments, the game interface may further include a switching control. In one example, the switching control may be a virtual button in the game interface and may be arranged in a lower edge zone of the game interface. Furthermore, in a specific implementation, the displaying the updated shooting state in the game interface may specifically include: displaying the updated shooting state of the target virtual item in the switching control.

It should be noted that the shooting state of the target virtual item in the single-fire mode is generally the single-fire state initially, and after the shooting state is updated to the burst-fire state, the target virtual item can still be in the single-fire mode, and more specifically, the update of the shooting state does not change the shooting mode of the target virtual item. Furthermore, once the user ends the first control operation, the shooting state of the target virtual item in the single-fire mode can be repeatedly restored to the initial single-fire state.

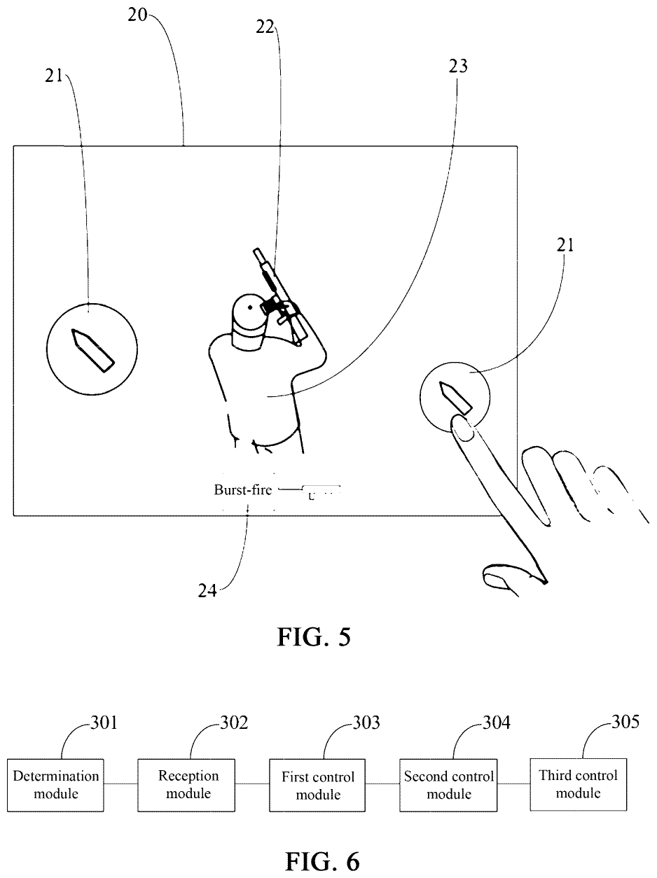

In one example, as shown in FIG. 3 and FIG. 5, corresponding symbols may be directly added to the switching control 24 included in the game interface 20 to indicate the current shooting state of the target virtual item 22. For example, a text identification “single-fire” may be added to an icon of the switching control 24 to indicate that the current shooting state of the target virtual item 22 is the single-fire state, a text identification “burst-fire” may be added to the icon of the switching control 24 to indicate that the current shooting state of the target virtual item 22 is the burst-fire state, and a text identification “transition from single-fire to burst-fire” may be added to the icon of the switching control 24 to indicate that the current shooting state of the target virtual item 22 is the shooting state transitioning from single-fire to burst-fire.

In some embodiments, the apparatus for controlling shooting in a game may further include: switching the shooting mode of the target virtual item to the burst-fire mode when the target virtual item fires the sub-virtual items at the second preset time interval. Specifically, during the first pressing operation, when the time interval between two adjacent shootings when the target virtual item carries out burst fire is reduced to the second preset time interval, the apparatus for controlling shooting in a game may switch the shooting mode of the target virtual item to the burst-fire mode. Therefore, the shooting mode of the target virtual item may be switched from the single-fire mode to the burst-fire mode through the attack control without interrupting the shooting process of the target virtual item, thereby further reducing the complexity of the shooting operation of the user and further improving the continuity of the game user performing the shooting operation.

In some embodiments, the above method for controlling shooting in a game may further include the following steps.

S110: Determine that the shooting mode of the target virtual item is the burst-fire mode.

S111: In response to receiving a third control operation for the attack control, control, in the burst-fire mode of the target virtual item, the target virtual item to continuously fire a preset number of sub-virtual items.

The third control operation may be a click operation. The preset number may be a natural number greater than 1. In an example, the preset number may be 3. In this way, the target virtual item in the burst-fire mode can perform a burst-fire when the user performs the third control operation on the attack control.

In some embodiments, after determining that the shooting mode of the target virtual item is the burst-fire mode, the method for controlling shooting in a game may further include the following steps.

S112: Receive a fourth control operation for the attack control, the fourth control operation including a second pressing operation and a second lifting operation.

S113: In response to the second pressing operation, control, in the burst-fire mode of the target virtual item, the target virtual item to fire the sub-virtual items at a second preset time interval.

S114: In response to the second lifting operation, control the target virtual item to stop firing the sub-virtual items.

The fourth control operation may be a long-press operation. Moreover, the second pressing operation occurs before the second lifting operation, and more specifically, the apparatus for controlling shooting in the game may first receive the second pressing operation and then receive the second lifting operation.

Specifically, when receiving the second pressing operation, the apparatus for controlling shooting in a game may, in response to receiving the second pressing operation, control, in the burst-fire mode of the target virtual item, the target virtual item to fire the sub-virtual items at the second preset time interval.

Specifically, when receiving the second lifting operation, the apparatus for controlling shooting in a game may, in response to receiving the second lifting operation, control the target virtual item to stop firing the sub-virtual items.

In this way, the target virtual item in the burst-fire mode can carry out burst fire during the user pressing the attack control.

In addition, it should be noted that, when the target virtual item in the single-fire mode carries out burst fire during the user pressing the attack control, the user needs to press the attack control for a duration longer than the first preset duration before burst fire is carried out; in contrast, when the target virtual item in the burst-fire mode carries out burst fire during the user pressing the attack control, burst fire can be carried out even if the user presses the attack control for a duration that does not meet the first preset duration. More specifically, from the moment the user starts pressing the attack control, every time the duration of the user pressing the attack control increases by the second preset time interval, the apparatus for controlling shooting in a game may control the target virtual item to carry out shooting once.

In some embodiments, the above method for controlling shooting in a game may further include: S115: In response to receiving a second control operation for the switching control, switch the shooting mode of the target virtual item to a next shooting mode.

The second control operation may be a click operation, a press operation, or a heavy-press operation, and the next mode switched to may be the burst-fire mode or another shooting mode. Specifically, when the current shooting mode of the target virtual item is the burst-fire mode, the next shooting mode corresponding to the target virtual item may be the single-fire mode. When the current shooting mode of the target virtual item is the single-fire mode, the next shooting mode corresponding to the target virtual item may be the burst-fire mode.

In one example, when the next shooting mode is the burst-fire mode, and after the shooting mode of the target virtual item is switched to the burst-fire mode, the apparatus for controlling shooting in a game may determine that the shooting mode of the target virtual item is the burst-fire mode, and then the S111 may be performed. Each time the S111 is performed, the corresponding target virtual item may carry out a burst-fire once. In addition, the S112, S113, and S114 may further be performed to enable the target virtual item to carry out burst fire by firing the sub-virtual items at the second preset time interval during the user pressing a shooting control.

As can be known from the above, the method for controlling shooting in a game provided in this embodiment provides the game interface through the terminal device, where the game interface includes the attack control; determines that the shooting mode of the target virtual item in the game is the single-fire mode; receives the first control operation for the attack control, the first control operation including the first pressing operation and the first lifting operation; in response to the first pressing operation, controls the target virtual item to fire a sub-virtual item; in response to the duration of the first pressing operation meeting the first preset duration, controls, in the single-fire mode of the target virtual item, the target virtual item to fire the sub-virtual items at the first preset time interval; and in response to the duration of the first pressing operation meeting the second preset duration, controls the target virtual item to fire the sub-virtual items at the second preset time interval, where the second preset duration is longer than the first preset duration, and the second preset time interval is the time interval for the target virtual item to fire the sub-virtual items in the burst-fire mode. Therefore, when the target virtual item is in the single-fire mode, the target virtual item can carry out burst fire without the need to switch the shooting mode of the target virtual item, which reduces the complexity of the shooting operation of the user, improves the continuity of the game user performing the shooting operation, and can provide the user with the feeling of the target virtual item transitioning from the single-fire state to the burst-fire state, thereby greatly improving the gaming experience of the user.

On the basis of the method described in the above embodiment, this embodiment may be further described from the perspective of an apparatus for controlling shooting in a game. Referring to FIG. 6, FIG. 6 specifically describes the apparatus for controlling shooting in a game according to an embodiment of the present disclosure. The apparatus for controlling shooting in a game provides a game interface through a terminal device, and the game interface includes an attack control. The apparatus for controlling shooting in a game includes: a determination module 301, a reception module 302, a first control module 303, a second control module 304, and a third control module 305.

(1) Determination module 301: The determination module 301 is configured to determine that a shooting mode of a target virtual item in the game is a single-fire mode.

(2) Reception module 302: The reception module 302 is configured to receive a first control operation for an attack control, the first control operation including a first pressing operation and a first lifting operation.

(3) First control module 303: The first control module 303 is configured to, in response to the first pressing operation, control the target virtual item to fire a sub-virtual item.

(4) Second control module 304: The second control module 304 is configured to, in response to a duration of the first pressing operation meeting a first preset duration, control, in the single-fire mode of the target virtual item, the target virtual item to fire the sub-virtual items at a first preset time interval.

(5) Third control module 305: The third control module 305 is configured to, in response to the duration of the first pressing operation meeting a second preset duration, control the target virtual item to fire the sub-virtual items at a second preset time interval, where the second preset duration is longer than the first preset duration, and the second preset time interval is a time interval for the target virtual item to fire the sub-virtual items in a burst-fire mode.

Specifically, before controlling the target virtual item to fire the sub-virtual items at the second preset time interval, the third control module 305 is further configured to control the target virtual item to fire the sub-virtual items at a time interval gradually decreasing from the first preset time interval to the second preset time interval.

In some embodiments, the apparatus for controlling shooting in a game may further include (6) Fourth control module: a fourth control module configured to, in response to the first lifting operation, control the target virtual item to stop firing the sub-virtual item.

In some embodiments, the apparatus for controlling shooting in a game may further include (7) Update module: an update module configured to update, in the single-fire mode of the target virtual item, the shooting state of the target virtual item to a burst-fire state when the target virtual item fires the sub-virtual items at the second preset time interval; and (8) Display module: a display module configured to display the updated shooting state in the game interface.

In some embodiments, the game interface may further include a switching control, and the apparatus for controlling shooting in a game may further include (9) Switching module: a switching module configured to, in response to receiving a second control operation for the switching control, switch the shooting mode of the target virtual item to a next shooting mode.

In some embodiments, the determination module 301 may further be configured to determine that the shooting mode of the target virtual item is the burst-fire mode.

Moreover, the apparatus for controlling shooting in a game may further include (10) Fifth control module: a fifth control module configured to, in response to receiving a third control operation for the attack control, control, in the burst-fire mode of the target virtual item, the target virtual item to continuously shoot a preset number of sub-virtual items.

In some embodiments, the determination module 301 may further be configured to determine that the shooting mode of the target virtual item is the burst-fire mode.

The reception module 302 may further be configured to receive a fourth control operation for the attack control, the fourth control operation including a second pressing operation and a second lifting operation.

Moreover, the apparatus for controlling shooting in a game may further include (11) Sixth control module: a sixth control module configured to, in response to the second pressing operation, control, in the burst-fire mode of the target virtual item, the target virtual item to fire the sub-virtual items at the second preset time interval; and (12) Seventh control module: a seventh control module configured to, in response to the second lifting operation, control the target virtual item to stop firing the sub-virtual items.

During specific implementation, the above modules can be implemented as independent entities, or can be arbitrarily combined and implemented as the same or several entities. The specific implementation of the above modules can be found with reference to the previous method embodiments, which may not be repeated here.

As can be known from the above, the apparatus for controlling shooting in a game provided in this embodiment provides the game interface through the terminal device, and the game interface includes the attack control. Moreover, the apparatus includes: the determination module configured to determine that the shooting mode of the target virtual item in the game is the single-fire mode; the reception module configured to receive the first control operation for the attack control, the first control operation including the first pressing operation and the first lifting operation; the first control module configured to, in response to the first pressing operation, control the target virtual item to fire the sub-virtual item; the second control module configured to, in response to the duration of the first pressing operation meeting the first preset duration, control, in the single-fire mode of the target virtual item, the target virtual item to fire the sub-virtual items at the first preset time interval; the third control module configured to, in response to the duration of the first pressing operation meeting the second preset duration, control the target virtual item to fire the sub-virtual items at the second preset time interval, where the second preset duration is longer than the first preset duration, and the second preset time interval is the time interval for the target virtual item to fire the sub-virtual items in the burst-fire mode. Therefore, when the target virtual item is in the single-fire mode, the target virtual item can carry out burst fire without the need to switch the shooting mode of the target virtual item, which reduces the complexity of the shooting operation of the user, improves the continuity of the game user performing the shooting operation, and can provide the user with the feeling of the target virtual item transitioning from the single-fire state to the burst-fire state, thereby greatly improving the gaming experience of the user.

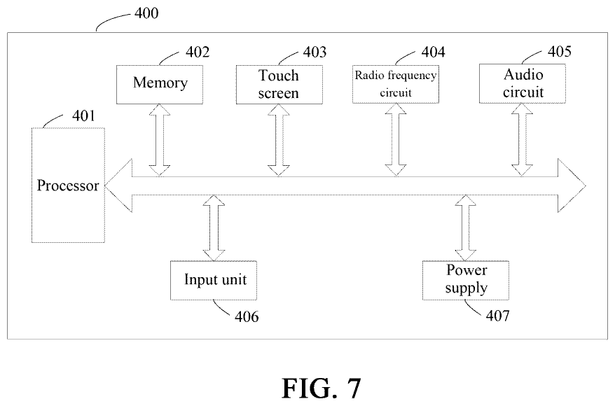

Accordingly, an embodiment of the present disclosure further provides a computer device. The computer device may be a terminal or a server. The terminal may be a terminal device, such as a smart phone, a tablet computer, a notebook computer, a touch screen, a game machine, a Personal Computer (PC), or a Personal Digital Assistant (PDA). As shown in FIG. 7, FIG. 7 is a schematic structural diagram of an electronic device according to an embodiment of the present disclosure. The electronic device 400 includes a processor 401 with one or more processing cores, a memory 402 with one or more computer-readable storage media, and a computer program stored on the memory 402 and executable on the processor. The processor 401 is electrically connected to the memory 402. It should be understood by those skilled in the art that the structure of the electronic device shown in the figure does not limit the electronic device. The electronic device may include more or fewer components than shown, combine certain components, or adopt a different component arrangement.

The processor 401 is a control center of the electronic device 400, connecting various parts of the electronic device 400 through various interfaces and circuits. By executing or loading software programs and/or modules stored in the memory 402, and invoking data stored in the memory 402, the processor performs various functions of the electronic device 400 and processes data.

In the embodiment of the present disclosure, the processor 401 in the electronic device 400 may load instructions corresponding to the processes of one or more applications into the memory 402 according to the following steps, and the processor 401 may run the applications stored in the memory 402 to achieve various functions: providing a game interface through a terminal device, the game interface including an attack control; determining that a shooting mode of a target virtual item in the game is a single-fire mode; receiving a first control operation for an attack control, the first control operation including a first pressing operation and a first lifting operation; in response to the first pressing operation, controlling the target virtual item to fire a sub-virtual item; in response to a duration of the first pressing operation meeting a first preset duration, controlling, in the single-fire mode of the target virtual item, the target virtual item to fire the sub-virtual items at a first preset time interval; and in response to the duration of the first pressing operation meeting a second preset duration, controlling the target virtual item to fire the sub-virtual items at a second preset time interval, where the second preset duration is longer than the first preset duration, and the second preset time interval is a time interval for the target virtual item to fire the sub-virtual items in a burst-fire mode.

In an example, before controlling the target virtual item to fire the sub-virtual items at the second preset time interval, the functions include: in response to the duration of the first pressing operation meeting a second preset duration, controlling the target virtual item to fire the sub-virtual items at a time interval gradually decreasing from the first preset time interval to the second preset time interval.

In an example, the functions further include: updating, in the single-fire mode of the target virtual item, the shooting state of the target virtual item to a burst-fire state when the target virtual item fires the sub-virtual items at the second preset time interval; and displaying the updated shooting state in the game interface.

In an example, the functions further include: in response to the first lifting operation, controlling the target virtual item to stop firing the sub-virtual item.

In an example, the game interface includes a switching control, and the functions further include: in response to receiving a second control operation for the switching control, switching the shooting mode of the target virtual item to a next shooting mode.

In an example, the functions further include: determining that the shooting mode of the target virtual item is the burst-fire mode; and in response to receiving a third control operation for the attack control, controlling, in the burst-fire mode of the target virtual item, the target virtual item to continuously shoot a preset number of sub-virtual items.

In an example, the functions further include: determining that the shooting mode of the target virtual item is the burst-fire mode; receiving a fourth control operation for the attack control, the fourth control operation including a second pressing operation and a second lifting operation; in response to the second pressing operation, controlling, in the burst-fire mode of the target virtual item, the target virtual item to fire the sub-virtual items at the second preset time interval; and in response to the second lifting operation, controlling the target virtual item to stop firing the sub-virtual items.

For the specific process of the above operations, reference may be made to the foregoing embodiments, and are not repeated herein.

In some embodiments, as shown in FIG. 7, the electronic device 400 further includes: a touch screen 403, a radio frequency circuit 404, an audio circuit 405, an input unit 406, and a power supply 407. The processor 401 is electrically connected to the touch screen 403, the radio frequency circuit 404, the audio circuit 405, the input unit 406, and the power supply 407, respectively. It should be understood by those skilled in the art that the structure of the electronic device shown in FIG. 7 does not limit the electronic device. The electronic device may include more or fewer components than shown, combine certain components, or adopt a different component arrangement.

The touch screen 403 may be configured to display a graphical user interface and receive an operating instruction generated by a user acting on the graphical user interface. The touch screen 403 may include a display panel and a touch panel. The display panel may be configured to display information input by the user or information provided to the user, and various graphical user interfaces of the electronic device. These graphical user interfaces can be composed of graphics, text, icons, videos, or any combination thereof. In some embodiments, the display panel may be configured in the form of a liquid crystal display (LCD) or an organic light-emitting diode (OLED), among others. The touch panel may be configured to collect a touch operation of the user thereon or in the vicinity thereof (such as an operation of the user on or in the vicinity of the touch panel using a finger, a touchpen, or any appropriate object or accessory), and generate a corresponding operating instruction, and the operating instruction executes a corresponding program. In some embodiments, the touch panel may include two parts: a touch detection apparatus and a touch controller. The touch detection apparatus detects a touch orientation of the user, detects a signal brought by the touch operation, and transmits the signal to the touch controller. The touch controller receives touch information from the touch detection apparatus, converts it into contact point coordinates, then transmits the contact point coordinates to the processor 401, can receive a command transmitted from the processor 401, and can execute the command. The touch panel can cover the display panel. After detecting the touch operation on or in the vicinity of the touch panel, the touch panel transmits the touch operation to the processor 401 to determine a type of a touch event, and then the processor 401 provides a corresponding visual output on the display panel based on the type of the touch event. In an embodiment of the present disclosure, the touch panel and the display panel may be integrated into the touch screen 403 to implement input and output functions. However, in some embodiments, the touch panel and the touch panel may be used as two standalone components to implement input and output functions. More specifically, the touch screen 403 may also be used as a part of the input unit 406 to implement the input function.

In the embodiment of the present disclosure, the processor 401 executes a game application to generate a picture of a virtual three-dimensional scene on the touch screen 403. The picture includes a graphical user interface (UI interface), and the graphical user interface includes a second spatial orientation indicator. The second spatial orientation indicator displays a spatial orientation identification corresponding to the target object, and the spatial orientation identification is used to indicate the orientation of the target object.

The touch screen 403 is configured to present the picture of the virtual three-dimensional scene and the graphical user interface, and receive an operating instruction generated by a user acting on the graphical user interface.

The radio frequency circuit 404 may be used to send and receive radio frequency signals, so as to establish wireless communication with network devices or other electronic devices, and to send and receive signals with the network devices or other electronic devices.

The audio circuit 405 may provide an audio interface between the user and the electronic device through a speaker and a microphone. The audio circuit 405 may convert the received audio data into electrical signals and then transmit the electronic signals to the speaker, the electronic signals are then converted by the speaker into sound signals for output. On the other hand, the microphone converts the collected sound signals into electrical signals, the electrical signals are received by the audio circuit 405 and then converted into audio data. The audio data is then either output to the processor 401 for processing, or sent via the radio frequency circuit 404 to another electronic device, for example. In some embodiments, the audio data is output to the memory 402 for further processing. The audio circuit 405 may also include an earphone jack to provide communication between peripheral headphones and the electronic device.

The input unit 406 may be configured to receive an input number, character information, or user feature information (such as a fingerprint, an iris, or facial information), and generate keyboard, mouse, joystick, optical, or trackball signal input related to user settings and function control.

The power supply 407 is configured to supply power to the various components of the electronic device 400. In some embodiments, the power supply 407 may be logically connected to the processor 401 through a power management system, thereby managing functions such as charging, discharging, and power consumption management through the power management system. The power supply 407 may further include one or more DC or AC power supplies, recharging systems, power failure detection circuits, power converters or inverters, power status indicators, and any other components.

Although not shown in FIG. 7, the electronic device 400 may further include a camera, a sensor, a Wi-Fi module, a Bluetooth module, and the like, which are not described here in detail.

In the above embodiments, the descriptions on the embodiments have respective emphasis, and parts that are not described in detail in an embodiment may be obtained with reference to related descriptions in other embodiments.

As can be seen from the above, the electronic device provided in this embodiment can reduce the complexity of the shooting operation of the game user and improve the continuity of the shooting operation of the user, thereby improving the gaming experience of the user.

Those of ordinary skills in the art may understand that all or a part of the steps in the methods of the above embodiments may be completed through instructions, or be completed by controlling related hardware through instructions, where the instructions may be stored in a computer-readable storage medium, and loaded and executed by a processor.

Therefore, an embodiment of the present disclosure provides a computer-readable storage medium having a plurality of computer programs stored thereon, where the computer programs can be loaded by a processor to perform the steps of any of the method for controlling shooting in a game according the embodiments of the present disclosure. For example, the computer program may perform the following steps: providing a game interface through a terminal device, the game interface including an attack control; determining that a shooting mode of a target virtual item in the game is a single-fire mode; receiving a first control operation for an attack control, the first control operation including a first pressing operation and a first lifting operation; in response to the first pressing operation, controlling the target virtual item to fire a sub-virtual item; in response to a duration of the first pressing operation meeting a first preset duration, controlling, in the single-fire mode of the target virtual item, the target virtual item to fire the sub-virtual items at a first preset time interval; and in response to the duration of the first pressing operation meeting a second preset duration, controlling the target virtual item to fire the sub-virtual items at a second preset time interval, where the second preset duration is longer than the first preset duration, and the second preset time interval is a time interval for the target virtual item to fire the sub-virtual items in a burst-fire mode.

In an example, before controlling the target virtual item to fire the sub-virtual items at the second preset time interval, the steps include: in response to the duration of the first pressing operation meeting the second preset duration, controlling the target virtual item to fire the sub-virtual items at a time interval gradually decreasing from the first preset time interval to the second preset time interval.

In an example, the steps further include: updating, in the single-fire mode of the target virtual item, the shooting state of the target virtual item to a burst-fire state when the target virtual item fires the sub-virtual items at the second preset time interval; and displaying the updated shooting state in the game interface.

In an example, the steps further include: in response to the first lifting operation, controlling the target virtual item to stop firing the sub-virtual item.

In an example, the game interface includes a switching control, and the steps further include: in response to receiving a second control operation for the switching control, switching the shooting mode of the target virtual item to a next shooting mode.

In an example, the steps further include: determining that the shooting mode of the target virtual item is the burst-fire mode; and in response to receiving a third control operation for the attack control, controlling, in the burst-fire mode of the target virtual item, the target virtual item to continuously shoot a preset number of sub-virtual items.

In an example, the steps further include: determining that the shooting mode of the target virtual item is the burst-fire mode; receiving a fourth control operation for the attack control, the fourth control operation including a second pressing operation and a second lifting operation; in response to the second pressing operation, controlling, in the burst-fire mode of the target virtual item, the target virtual item to fire the sub-virtual items at the second preset time interval; and in response to the second lifting operation, controlling the target virtual item to stop firing the sub-virtual items.

For the specific process of the above operations, reference may be made to the foregoing embodiments, and are not repeated herein.

The storage medium may include: a Read Only Memory (ROM), a Random Access Memory (RAM), a magnetic disk, an optical disc, or the like. The computer program stored in the storage medium may perform the steps in any of the methods for controlling shooting in a game according to the embodiments of the present disclosure, and therefore, it may achieve the beneficial effects that can be achieved by the methods for controlling shooting in a game according to the embodiments of the present disclosure. For details, reference may be made to the previous embodiments, which may not be repeated here.

The above has provided a detailed description of a method and apparatus for controlling shooting in a game, a storage medium, and an electronic device according to the embodiments of the present disclosure. Specific examples are applied herein to elaborate on the principles and implementations of the present disclosure. The descriptions of the above embodiments are merely intended to facilitate understanding of the methods of the present disclosure and core ideas thereof. Meanwhile, for those skilled in the art, changes in specific implementations and application scopes may be made based on the ideas of the present disclosure. In summary, the content of this specification should not be construed as a limitation of the present disclosure.

1. A method for controlling shooting in a game, comprising:
determining that a shooting mode of a target virtual item in the game is a single-fire mode, wherein a game interface is provided through a terminal device, and the game interface comprises an attack control element;
receiving a first control operation for the attack control element, the first control operation comprising a first pressing operation and a first lifting operation;
in response to the first pressing operation, controlling the target virtual item to fire a sub-virtual item;
in response to a duration of the first pressing operation meeting a first preset duration, controlling, in the single-fire mode of the target virtual item, the target virtual item to fire the sub-virtual item at a first preset time interval; and
in response to the duration of the first pressing operation meeting a second preset duration, controlling the target virtual item to fire the sub-virtual item at a second preset time interval, wherein the second preset duration is longer than the first preset duration, and the second preset time interval corresponds to a time interval for the target virtual item to fire the sub-virtual item in a burst-fire mode.

2. The method according to claim 1, wherein, before controlling the target virtual item to fire the sub-virtual item at the second preset time interval, the method further comprises:
in response to the duration of the first pressing operation meeting the second preset duration, controlling the target virtual item to fire the sub-virtual item at a time interval gradually decreasing from the first preset time interval to the second preset time interval.

3. The method according to claim 2, further comprising:
updating, in the single-fire mode of the target virtual item, a shooting state of the target virtual item to a burst-fire state when the target virtual item fires the sub-virtual item at the second preset time interval; and
displaying the updated shooting state in the game interface.

4. The method according to claim 1, further comprising:
in response to the first lifting operation, controlling the target virtual item to stop firing the sub-virtual item.

5. The method according to claim 1, wherein the game interface comprises a switching control, and the method further comprises:
in response to receiving a second control operation for the switching control, switching the shooting mode of the target virtual item to a next shooting mode.

6. The method according to claim 1, further comprising:
determining that the shooting mode of the target virtual item is the burst-fire mode; and
in response to receiving a third control operation for the attack control element, controlling, in the burst-fire mode of the target virtual item, the target virtual item to continuously fire a preset number of sub-virtual items.

7. The method according to claim 1, further comprising:
determining that the shooting mode of the target virtual item is the burst-fire mode;
receiving a fourth control operation for the attack control element, the fourth control operation comprising a second pressing operation and a second lifting operation;
in response to the second pressing operation, controlling, in the burst-fire mode of the target virtual item, the target virtual item to fire the sub-virtual item at the second preset time interval; and
in response to the second lifting operation, controlling the target virtual item to stop firing the sub-virtual item.

8. (canceled)

9. One or more non-transitory computer-readable storage media containing, in any combination, computer program code that, when executable by a computer system, perform an operation comprising:
determining that a shooting mode of a target virtual item in a game is a single-fire mode, wherein a game interface is provided through a terminal device, and the game interface comprises an attack control element;
receiving a first control operation for the attack control element, the first control operation comprising a first pressing operation and a first lifting operation;
in response to the first pressing operation, controlling the target virtual item to fire a sub-virtual item;
in response to a duration of the first pressing operation meeting a first preset duration, controlling, in the single-fire mode of the target virtual item, the target virtual item to fire the sub-virtual item at a first preset time interval; and
in response to the duration of the first pressing operation meeting a second preset duration, controlling the target virtual item to fire the sub-virtual item at a second preset time interval, wherein the second preset duration is longer than the first preset duration, and the second preset time interval corresponds to a time interval for the target virtual item to fire the sub-virtual item in a burst-fire mode.

10. A system, comprising:
one or more memories collectively containing one or more programs; and
one or more processors, wherein the one or more processors are configured to, individually or collectively, perform an operation comprising:
determining that a shooting mode of a target virtual item in a game is a single-fire mode, wherein a game interface is provided through a terminal device, and the game interface comprises an attack control element;
receiving a first control operation for the attack control element, the first control operation comprising a first pressing operation and a first lifting operation;
in response to the first pressing operation, controlling the target virtual item to fire a sub-virtual item;
in response to a duration of the first pressing operation meeting a first preset duration, controlling, in the single-fire mode of the target virtual item, the target virtual item to fire the sub-virtual item at a first preset time interval; and
in response to the duration of the first pressing operation meeting a second preset duration, controlling the target virtual item to fire the sub-virtual item at a second preset time interval, wherein the second preset duration is longer than the first preset duration, and the second preset time interval corresponds to a time interval for the target virtual item to fire the sub-virtual item in a burst-fire mode.

11. The one or more non-transitory computer-readable storage media according to claim 9, wherein, before controlling the target virtual item to fire the sub-virtual item at the second preset time interval, the operation further comprises:
in response to the duration of the first pressing operation meeting the second preset duration, controlling the target virtual item to fire the sub-virtual item at a time interval gradually decreasing from the first preset time interval to the second preset time interval.

12. The one or more non-transitory computer-readable storage media according to claim 11, wherein the operation further comprises:
updating, in the single-fire mode of the target virtual item, a shooting state of the target virtual item to a burst-fire state when the target virtual item fires the sub-virtual item at the second preset time interval; and
displaying the updated shooting state in the game interface.

13. The one or more non-transitory computer-readable storage media according to claim 9, wherein the operation further comprises:
in response to the first lifting operation, controlling the target virtual item to stop firing the sub-virtual item.

14. The one or more non-transitory computer-readable storage media according to claim 9, wherein the game interface comprises a switching control, and the operation further comprises:
in response to receiving a second control operation for the switching control, switching the shooting mode of the target virtual item to a next shooting mode.

15. The one or more non-transitory computer-readable storage media according to claim 9, wherein the operation further comprises:
determining that the shooting mode of the target virtual item is the burst-fire mode; and
in response to receiving a third control operation for the attack control element, controlling, in the burst-fire mode of the target virtual item, the target virtual item to continuously fire a preset number of sub-virtual items.

16. The one or more non-transitory computer-readable storage media according to claim 9, wherein the operation further comprises:
determining that the shooting mode of the target virtual item is the burst-fire mode;
receiving a fourth control operation for the attack control element, the fourth control operation comprising a second pressing operation and a second lifting operation;
in response to the second pressing operation, controlling, in the burst-fire mode of the target virtual item, the target virtual item to fire the sub-virtual item at the second preset time interval; and
in response to the second lifting operation, controlling the target virtual item to stop firing the sub-virtual item.

17. The system according to claim 10, wherein, before controlling the target virtual item to fire the sub-virtual item at the second preset time interval, the operation further comprises:
in response to the duration of the first pressing operation meeting the second preset duration, controlling the target virtual item to fire the sub-virtual item at a time interval gradually decreasing from the first preset time interval to the second preset time interval.

18. The system according to claim 17, wherein the operation further comprises:
updating, in the single-fire mode of the target virtual item, a shooting state of the target virtual item to a burst-fire state when the target virtual item fires the sub-virtual item at the second preset time interval; and
displaying the updated shooting state in the game interface.

19. The system according to claim 10, wherein the operation further comprises:
in response to the first lifting operation, controlling the target virtual item to stop firing the sub-virtual item.

20. The system according to claim 10, wherein the game interface comprises a switching control, and the operation further comprises:
in response to receiving a second control operation for the switching control, switching the shooting mode of the target virtual item to a next shooting mode.

21. The system according to claim 10, wherein the operation further comprises:
determining that the shooting mode of the target virtual item is the burst-fire mode; and
in response to receiving a third control operation for the attack control element, controlling, in the burst-fire mode of the target virtual item, the target virtual item to continuously fire a preset number of sub-virtual items.
